(19) United States
(12) Patent Application Publication
(10) Pub. No.: US 2018/0231206 A1
(43) Pub. Date: Aug. 16, 2018

(54) LAMP DEVICE

(71) Applicant: KOITO MANUFACTURING CO., LTD., Tokyo (JP)

(72) Inventors: Hiroaki Hara, Shizuoka (JP); Hideaki Yamamoto, Shizuoka (JP)

(73) Assignee: KOITO MANUFACTURING CO., LTD., Tokyo (JP)

(21) Appl. No.: 15/894,604

(22) Filed: Feb. 12, 2018

(30) Foreign Application Priority Data
Feb. 10, 2017 (JP) 2017-023417

(51) Int. Cl. F21S 45/10; F21S 45/50; G01S 17/93; G01S 15/93; G01S 13/93

(52) U.S. Cl. CPC F21S 45/10; F21S 45/50; G01S 17/936; G01S 2013/9396; G01S 13/931; G01S 2015/937; G01S 15/931

(57) ABSTRACT

A lamp device to be mounted on a vehicle includes a housing, a translucent member defining a housing space together with the housing, a light source housed in the housing space, and a sensor housed in the housing space and configured to detect information outside the vehicle. The translucent member includes a first portion and a second portion. The first portion includes a region through which light emitted from the light source passes and has first weather resistance. The second portion includes a region opposing the sensor and has second weather resistance, and the second weather resistance is higher than the first weather resistance.

### CROSS-REFERENCE TO RELATED APPLICATIONS

The present application claims the benefit of priority of Japanese Patent Application No. 2017-023417, filed on Feb. 10, 2017, the content of which is incorporated herein by reference.

### TECHNICAL FIELD

The present invention relates to a lamp device to be mounted on a vehicle.

### BACKGROUND ART

In order to achieve driving support for a vehicle, it is necessary to mount on a vehicle body a sensor for acquiring information outside the vehicle. There has been known a lamp device including a sensor disposed in a lamp housing for housing a light source for emitting light toward a predetermined region around a vehicle (for example, see JP-A-2016-187990).

A housing space for housing the light source and the sensor is defined by the lamp housing and a translucent member attached to the lamp housing.

As described above, the sensor disposed in the housing space acquires information outside the vehicle through the translucent member. The translucent member may be generally formed by applying a hard coat to an outer surface of polycarbonate resin. In this case, when light transmission characteristics of the translucent member change over long-term use, accuracy of information acquisition by the sensor may be affected.

### SUMMARY

Accordingly, an aspect of the present invention provides a lamp device which includes a light source and a sensor disposed in a space defined by a translucent member and a housing and can maintain accuracy of information acquisition by the sensor over a long term.

According to an aspect of the present invention, there is provided a lamp device to be mounted on a vehicle, the lamp device including:

a housing;

a translucent member defining a housing space together with the housing;

a light source housed in the housing space; and

a sensor housed in the housing space and configured to detect information outside the vehicle, wherein the translucent member includes a first portion and a second portion, wherein the first portion includes a region through which light emitted from the light source passes and has first weather resistance, and wherein the second portion includes a region opposing the sensor and has second weather resistance, and the second weather resistance is higher than the first weather resistance.

In the above lamp device, the sensor may include at least one of a LiDAR sensor, a millimeter wave radar, an ultrasonic sensor, and a camera.

That is, the translucent member defining the housing space for housing the light source and the sensor together with the housing includes the first portion and the second portion having different weather resistance. In the second portion having higher weather resistance, the light transmission characteristic is hard to change over long-term use. Since the second portion includes the region opposing the sensor, accuracy of information acquisition by the sensor over a long term can be maintained.

In the above lamp device, the second portion may be made of either one of glass, acrylic resin, and bio-polycarbonate resin.

The above lamp device may further include an opaque member covering at least one part of a first end edge of the first portion and at least one part of a second end edge of the second portion.

Alternatively, the above lamp device may include an opaque member having a portion which is flush with at least one of (i) at least one part of a first end edge of the first portion and (ii) at least one part of a second end edge of the second portion.

According to these configurations, it is possible to make it difficult to visually recognize a boundary between the first portion and the second portion with different weather resistance. Accordingly, unnatural feeling given to a user over long-term use can be suppressed even though the translucent member has the first portion and the second portion with different weather resistance.

In the above lamp device, the opaque member may present a same color as a part of a vehicle body of the vehicle.

According to this configuration, a natural appearance can be provided that the opaque member, which makes it difficult to visually recognize the boundary between the first portion and the second portion of the translucent member with different weather resistance, is a part of the vehicle body. The unnatural feeling given to the user over long-term use can be further suppressed even though the translucent member has the first portion and the second portion with different weather resistance.

In the above lamp device, the second portion may be smaller than the first portion.

If the entire translucent member were formed with a material having higher weather resistance, various problems would be considered. For example, acrylic resin is worse in impact resistance compared with polycarbonate resin and the like. However, if the second portion occupying a relatively small region of the translucent member is made of acrylic resin, it is easy to achieve the desired impact resistance. Glass has high impact resistance but has difficulty in weight and molding freedom (i.e. design freedom). However, if the second portion occupying a relatively small region of the translucent member is made of glass, the influence on the weight of the entire translucent member and the design freedom can be reduced.

In the above lamp device, the second portion may include a portion having a lens function.

According to this configuration, at least a part of an optical system disposed in the housing space for the sensor to operate may be omitted. Accordingly, an increase in size of the lamp device can be suppressed.

In the above lamp device, the first portion and the second portion may be a part of an integral molded product.

According to this configuration, the number of the parts can be reduced.

### BRIEF DESCRIPTION OF THE DRAWINGS

The above and other aspects of the present invention will become more apparent and more readily appreciated from the following description of illustrative embodiments of the present invention taken in conjunction with the attached drawings, in which:

FIG. 1 is a diagram showing positions of lamp devices in a vehicle according to a first embodiment;

FIG. 2 is a diagram schematically showing an internal configuration of one of the lamp devices in FIG. 1;

FIG. 3 is a diagram showing a first modification of the lamp device in FIG. 1;

FIG. 4 is a diagram showing a second modification of the lamp device in FIG. 1;

FIG. 5 is a diagram showing a position of a lamp device in a vehicle according to a second embodiment.

FIG. 6 is a diagram schematically showing an internal configuration of the lamp device in FIG. 5.

FIG. 7 is a diagram showing a first modification of the lamp device in FIG. 5.

FIG. 8 is a diagram showing a second modification of the lamp device in FIG. 5.

FIG. 9 is a diagram showing a third modification of the lamp device in FIG. 5.

### DETAILED DESCRIPTION

Embodiments will be described in detail below with reference to the drawings. In each drawing used in the following description, the scale is appropriately changed in order to make each member in a recognizable size.

In the drawings, Arrow F indicates a forward direction of an illustrated structure. Arrow B indicates a backward direction of the illustrated structure. Arrow U indicates an upward direction of the illustrated structure. Arrow D indicates a downward direction of the illustrated structure. Arrow L indicates a left direction of the illustrated structure. Arrow R indicates a right direction of the structure shown. The “left” and “right” used in the following description indicate the left and right directions viewed from a driver's seat.

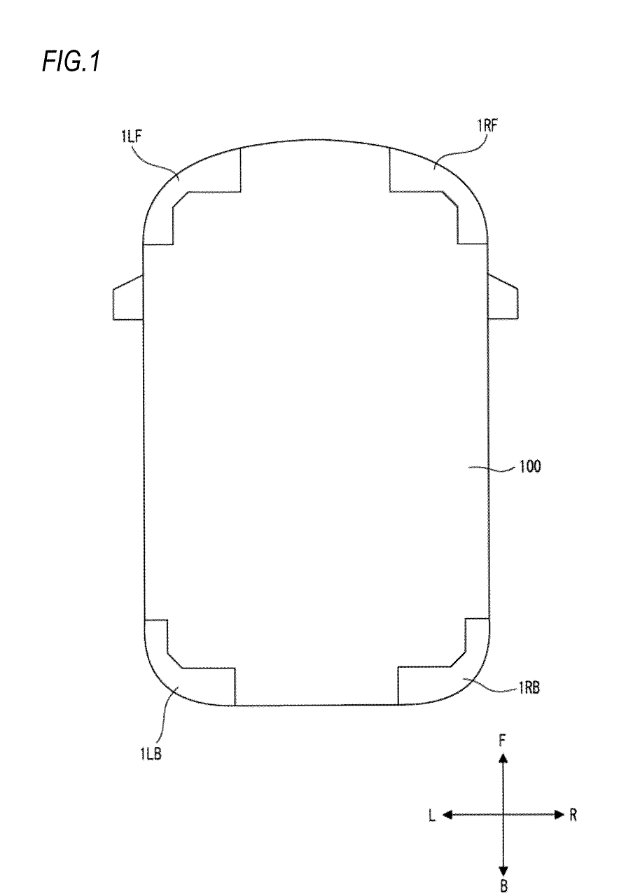

As shown in FIG. 1, a left-front lamp device 1LF according to a first embodiment is mounted on a left-front corner portion of a vehicle 100. A right-front lamp device 1RF according to the first embodiment is mounted on a right-front corner portion of the vehicle 100.

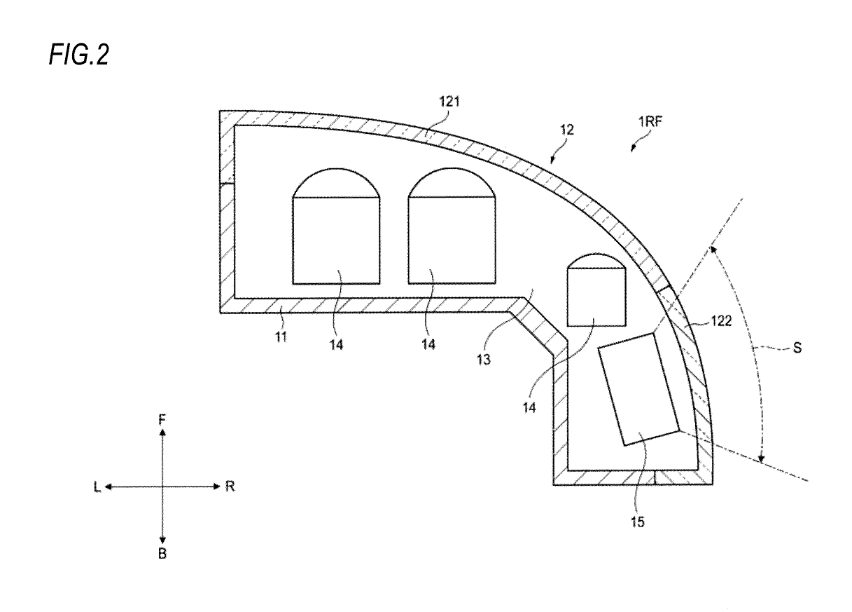

FIG. 2 schematically shows an internal configuration of the right-front lamp device 1RF viewed from a top of the vehicle 100. Although the drawing is omitted, the left-front lamp device 1LF has a configuration which is symmetrical with the right-front lamp device 1RF.

The right-front lamp device 1RF includes a housing 11 and a translucent member 12. The housing 11 and the translucent member 12 define a lamp room 13 (an example of a housing space).

The right-front lamp device 1RF includes a light source 14. The light source 14 includes an optical system including at least one of a lens and a reflector and emits light for illuminating a predetermined region. The light source 14 is disposed in the lamp room 13. A lamp light source and/or a semiconductor light emitting element may be used in the light source 14. Examples of the lamp light source include an incandescent lamp, a halogen lamp, a discharge lamp, a neon lamp and the like. Examples of the semiconductor light emitting element include a light emitting diode, a laser diode, an organic EL element and the like.

The right-front lamp device 1RF includes a LiDAR sensor 15. The LiDAR sensor 15 includes an element for emitting invisible light and an element for detecting return light resulting from reflection of the invisible light to an object present outside the vehicle 100. In this embodiment, infrared light having a wavelength of 905 nm is used as the invisible light. The LiDAR sensor 15 may include a scanning mechanism for sweeping the invisible light by changing an emission direction (i.e. a detection direction).

The LiDAR sensor 15 is a sensor for acquiring information outside the vehicle 100. For example, a distance to an object associated with the return light can be acquired based on a time period between a time of emitting the infrared light in a certain direction and a time of detecting the return light. In addition, information on a shape of the object associated with the return light can be acquired by accumulating such distance data associated with detection positions. Alternatively or additionally, information on an attribute, such as a material, of the object associated with the return light can be acquired based on a difference between the emitted light and the return light. Alternatively or additionally, information on a color of the object (a white line, etc. on a road surface) can be acquired based on a difference in a reflectivity of the return light from the road surface, for example.

The LiDAR sensor 15 outputs a signal corresponding to the detected attribute (intensity, a wavelength, or the like) of the return light. The above information is acquired by appropriately processing the signal output from the LiDAR sensor 15 by an information processing unit or a processor (not shown). The information processing unit or the processor may be included in the right-front lamp device 1RF, or may be mounted in the vehicle 100.

The translucent member 12 includes a first portion 121 and a second portion 122. The first portion 121 includes a region through which the light emitted from the light source 14 passes. Specifically, the first portion 121 is disposed so as to cover at least an irradiation range (a solid angle) of the light emitted from the light source 14. The second portion 122 includes a region opposing the LiDAR sensor 15. Specifically, the second portion 122 is disposed so as to cover at least a detection range (a solid angle) of the LiDAR sensor 15.

The light emitted from the light source 14 passes through the first portion 121 of the translucent member 12 and illuminates the predetermined region outside the vehicle 100. At least a part of wavelength of the light emitted from the light source 14 is included in a visible light region.

The infrared light emitted from the LiDAR sensor 15 passes through the second portion 122 of the translucent member 12 and irradiates the predetermined region outside the vehicle 100. A range S indicated by a chain line in FIG. 2 represents a range which can be irradiated (detected). The return light as a result of being reflected by the irradiated object passes through the second portion 122 and is detected by the LiDAR sensor 15.

The first portion 121 has first weather resistance. The term “weather resistance” refers to durability against degradation due mainly to sunlight, rain and snow, temperature, humidity, and ozone in a natural environment. The expression “weather resistance is high” refers that such durability is high. The second portion 122 has second weather resistance. The second weather resistance is higher than the first weather resistance. That is, the weather resistance of the second portion 122 is higher than the weather resistance of the first portion 121.

The first portion 121 is made of, for example, polycarbonate resin. The second portion 122 is made of, for example, either one of glass, acrylic resin, and bio-polycarbonate resin. A combination of a material for forming the first portion 121 and a material for forming the second portion 122 can be selected appropriately so as to satisfy the above weather resistance relationship.

That is, the translucent member 12 defining the lamp room 13 for housing the light source 14 and the LiDAR sensor 15 together with the housing includes the first portion 121 and the second portion 122 having different weather resistance. In the second portion 122 having higher weather resistance, the light transmission characteristic is hard to change over long-term use. Since the second portion 122 includes the region opposing the LiDAR sensor 15, the accuracy of information acquisition by the LiDAR sensor 15 over a long term can be maintained.

In this embodiment, the first portion 121 and the second portion 122 of the translucent member 12 are in contact with each other. The first portion 121 and the second portion 122 may be bonded by adhesion or welding, or may be provided as an integral molded product in advance. In the latter case, the number of parts can be reduced.

In this embodiment, the second portion 122 of the translucent member 12 is smaller than the first portion 121.

If the entire translucent member 12 were formed with a material having higher weather resistance, various problems would be considered. For example, acrylic resin is worse in impact resistance compared with polycarbonate resin and the like. However, if the second portion 122 occupying a relatively small region of the translucent member 12 is made of acrylic resin, it is easy to achieve the desired impact resistance. Glass has high impact resistance but has difficulty in weight and molding freedom (i.e. design freedom). However, if the second portion 122 occupying a relatively small region of the translucent member 12 is made of glass, the influence on the weight of the entire translucent member 12 and the design freedom can be reduced.

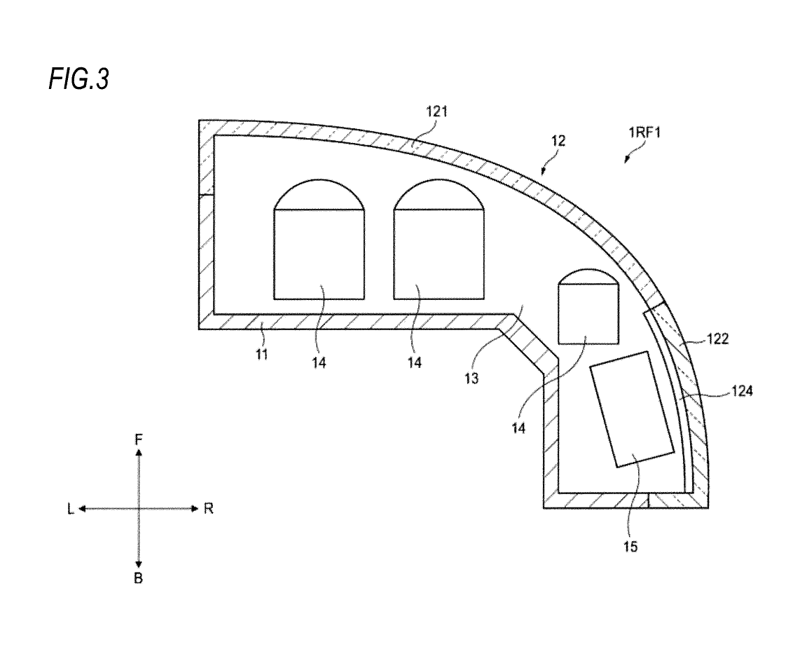

FIG. 3 schematically shows a right-front lamp device 1RF1 according to a first modification of the first embodiment. Constituent elements common to the right-front lamp device 1RF are denoted by the same reference numerals, and repetitive explanation is omitted.

In this modification, an anti-reflection layer 124 is provided on an inner surface of the second portion 122 of the translucent member 12. The anti-reflection layer 124 has a so-called moth-eye structure. Specifically, a convex-concave structure is formed which is repeated at a cycle shorter than the wavelength of the detected light of the LiDAR sensor 15.

According to this configuration, light transmittance of the detected light of the LiDAR sensor 15 in the second portion 122 can be enhanced. Therefore, the accuracy of information acquisition by the LiDAR sensor 15 can be enhanced and the accuracy can be maintained over a long term.

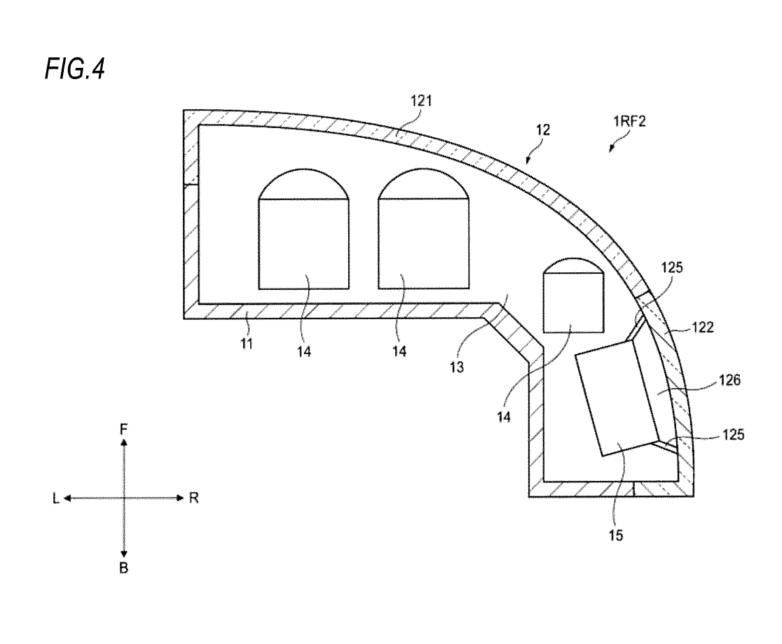

FIG. 4 is a diagram schematically showing a right-front lamp device 1RF2 according to a second modification of the first embodiment. Constituent elements common to the right-front lamp device 1RF are denoted by the same reference numerals, and repetitive explanation is omitted.

The right-front lamp device 1RF2 includes a wall member 125. The wall member 125 partitions a space between the inner surface of the second portion 122 of the translucent member 12 and the LiDAR sensor 15. The space is filled with silicone gel 126.

According to this configuration, the inner surface of the second portion 122 which the LiDAR sensor 15 opposes can be prevented from being fogged. Further, a part of the material component forming the second portion 122 can be prevented from being volatilized into the lamp room 13 as the temperature rises. Therefore, the accuracy of information acquisition by the LiDAR sensor 15 can be enhanced, and the accuracy can be maintained over a long term. In addition, the LiDAR sensor 15 opposing the second portion 122 can be protected from impact and contamination by the silicone gel 126.

The silicone gel 126 may be replaced by another gel material as long as the gel material can provide sufficient light transmittance (for example, 80% or more) with respect to the detected light of the LiDAR sensor 15.

In the above embodiments, the detected light of the LiDAR sensor 15 linearly passes through the second portion 122 of the translucent member 12. However, at least a part of the second portion 122 may have a shape having a lens function.

According to this configuration, since the LiDAR sensor 15 performs the desired detection operation, at least a part of the optical system disposed in the lamp room 13 may be omitted. Accordingly, an increase in size of the right-front lamp device 1RF can be suppressed.

In the above embodiments, a single housing space (the lamp room 13) is defined by the housing 11 and the translucent member 12. However, the inside of the housing space can be divided into a plurality of spaces by a partition plate and the like.

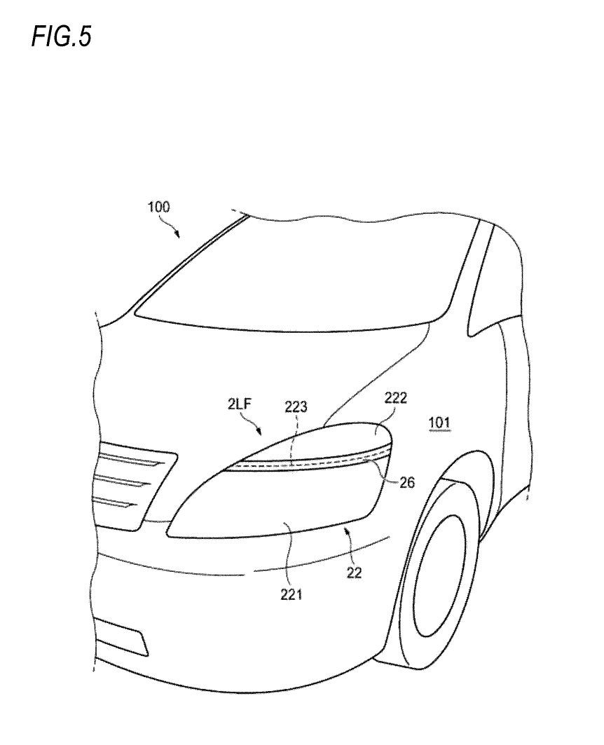

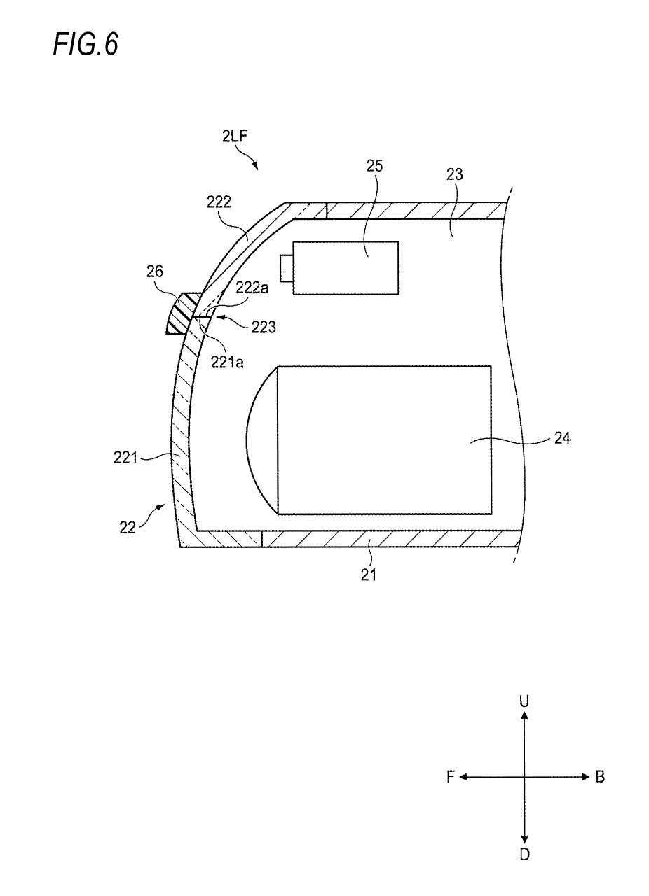

FIG. 5 schematically shows an appearance of a left-front lamp device 2LF mounted on the vehicle 100, according to a second embodiment. FIG. 6 schematically shows an internal configuration of the left-front lamp device 2LF viewed from left of the vehicle 100.

The left-front lamp device 2LF includes a housing 21 and a translucent member 22. The housing 21 and the translucent member 22 define a lamp room 23 (an example of the housing space).

The left-front lamp device 2LF includes a light source 24. The light source 24 includes an optical system including at least one of a lens and a reflector and emits light for illuminating a predetermined region. The light source 24 is disposed in the lamp room 23. A lamp light source and/or a semiconductor light emitting element may be used in the light source 24. Examples of the lamp light source include an incandescent lamp, a halogen lamp, a discharge lamp, a neon lamp and the like. Examples of the semiconductor light emitting element include a light emitting diode, a laser diode, an organic EL element and the like.

The left-front lamp device 2LF includes a camera 25. The camera 25 is a device which acquires an image of at least a front of the vehicle 100 (an example of outside of the vehicle). That is, the camera 25 is a sensor which detects information at least in front of the vehicle 100. The camera 25 is configured to output an image signal corresponding to the acquired image. The information on at least the front of the vehicle 100 detected by the camera 25 is acquired by appropriately processing the image signal by an information processing unit or a processor (not shown). The information processing unit or the processor may be included in the left-front lamp device 2LF, or may be mounted in the vehicle 100.

The translucent member 22 includes a first portion 221 and a second portion 222. The first portion 221 includes a region through which the light emitted from the light source 24 passes. Specifically, the first portion 221 is disposed so as to cover at least an irradiation range (a solid angle) of the light emitted from the light source 24. The second portion 222 includes a region opposing the camera 25. Specifically, the second portion 222 is disposed so as to cover at least a visual field of the camera 25.

The light emitted from the light source 24 passes through the first portion 221 of the translucent member 22 and illuminates the predetermined region outside the vehicle 100. At least a part of the wavelength of the light emitted from the light source 24 is included in a visible light region.

The camera 25 takes an image of at least the front of the vehicle 100 based on the light passing through the second portion 222 of the translucent member 22.

The first portion 221 has first weather resistance. The second portion 222 has second weather resistance. The second weather resistance is higher than the first weather resistance. That is, the weather resistance of the second portion 222 is higher than the weather resistance of the first portion 221.

The first portion 221 is made of, for example, polycarbonate resin. A hard coat is applied to an outer surface thereof. The second portion 222 is made of, for example, either one of glass, acrylic resin, and bio-polycarbonate resin. A combination of a material for forming the first portion 221 and a material for forming the second portion 222 can be selected appropriately so as to satisfy the above weather resistance relationship.

That is, the translucent member 22 defining the lamp room 23 for housing the light source 24 and the camera 25 together with the housing includes the first portion 221 and the second portion 222 having different weather resistance. In the second portion 222 having higher weather resistance, the light transmission characteristic is hard to change over long-term use. Since the second portion 222 includes the region opposing the camera 25, the accuracy of information acquisition by the camera 25 over a long term can be maintained.

In this embodiment, the left-front lamp device 2LF includes an opaque member 26. The opaque member 26 is made of, for example, opaque resin.

As shown in FIG. 5, the opaque member 26 extends along an outer surface of the translucent member 22. Specifically, as shown in FIG. 6, the opaque member 26 extends so as to cover an end edge 221a (an example of a first end edge) of the first portion 211 and an end edge 222a (an example of a second end edge) of the second portion 222 of the translucent member 22. In this embodiment, as shown in FIG. 5, the opaque member 26 covers an entire boundary 223 which is between the first portion 221 and the second portion 222 and formed by the end edge 221a and the end edge 222a.

In the present specification, the term “opaque” used for the opaque member 26 does not necessarily mean only a state where no visible light is transmitted. The transmittance of the opaque member 26 to the visible light should be included in a range of “opaque” if the transmittance is lower than the transmittance of the translucent member 22 to the visible light.

According to this configuration, it is possible to make it difficult to visually recognize the boundary 223 between the first portion 221 and the second portion 222 with different weather resistance. Accordingly, unnatural feeling given to a user over long-term use can be suppressed even though the translucent member 22 has the first portion 221 and the second portion 222 with different weather resistance.

In this embodiment, the opaque member 26 presents the same color as a part of a vehicle body 101 of the vehicle 100 (particularly, a portion adjacent to the left-front lamp device 2LF).

According to this configuration, a natural appearance can be provided that the opaque member 26, which makes it difficult to visually recognize the boundary between the first portion 221 and the second portion 222 of the translucent member 22 with different weather resistance, is a part of the vehicle body 101. The unnatural feeling given to a user over long-term use can be further suppressed even though the translucent member 22 has the first portion 221 and the second portion 222 with different weather resistance.

In this embodiment, the first portion 221 and the second portion 222 of the translucent member 22 are in contact with each other. The first portion 221 and the second portion 222 may be bonded by adhesion, or may be provided as an integral molded product in advance. In the latter case, the number of parts can be reduced.

In this embodiment, the second portion 222 of the translucent member 22 is smaller than the first portion 221.

If the entire translucent member 22 were formed with a material having higher weather resistance, various problems would be considered. For example, acrylic resin is worse in impact resistance compared with polycarbonate resin and the like. However, if the second portion 222 occupying a relatively small region of the translucent member 22 is made of acrylic resin, it is easy to achieve the desired impact resistance. Glass has high impact resistance but has difficulty in weight and molding freedom (i.e. design freedom). However, if the second portion 222 occupying a relatively small region of the translucent member 22 is made of glass, the influence on the weight of the entire translucent member 22 and the design freedom can be reduced.

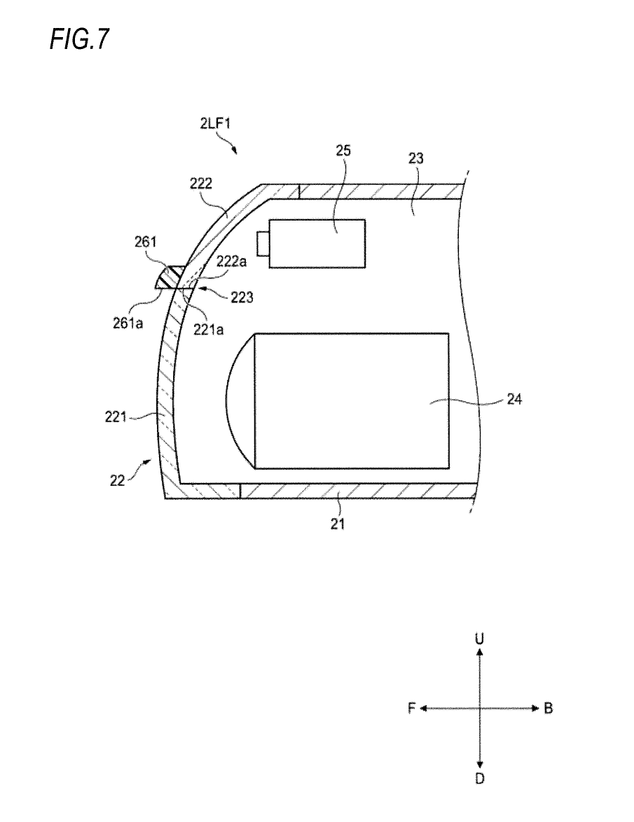

FIG. 7 shows a left-front lamp device 2LF1 according to a first modification of the second embodiment. Constituent elements common to the left-front lamp device 2LF are denoted by the same reference numerals, and repetitive explanation is omitted.

The left-front lamp device 2LF1 includes an opaque member 261. The opaque member 261 has an end surface 261a which is flush with the end edge 221a of the first portion 221 and the end edge 222a of the second portion 222 of the translucent member 22.

Even with this configuration, it is possible to make it difficult to visually recognize the boundary 223 between the first portion 221 and the second portion 222 with different weather resistance. Accordingly, unnatural feeling given to a user over long-term use can be suppressed even though the translucent member 22 has the first portion 221 and the second portion 222 with different weather resistance.

If it is possible to obtain the effect of making it difficult to visually recognize the boundary 223, the end surface 261a of the opaque member 261 may be disposed so as to form a slight step between the end edge 221a of the first portion 221 and the end edge 222a of the second portion 222.

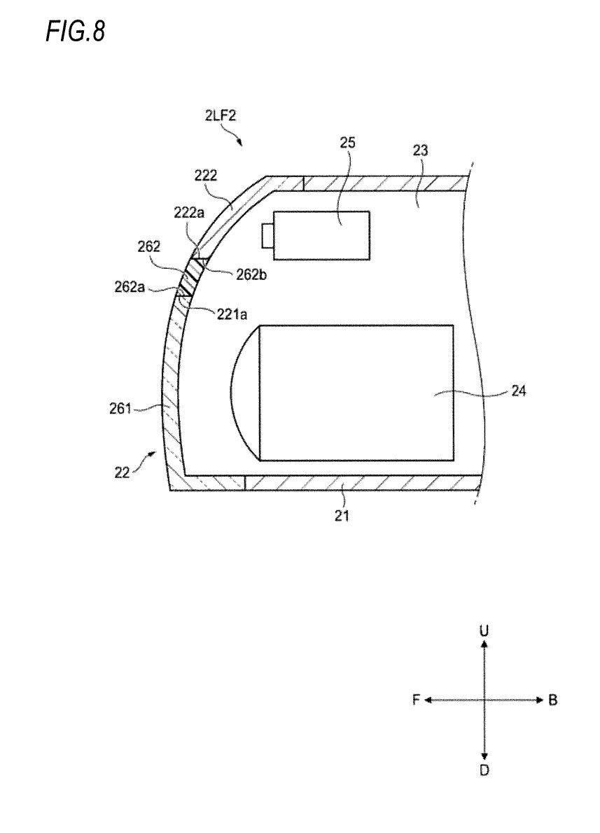

In the left-front lamp device 2LF and the left-front lamp device 2LF1, the end edge 221a of the first portion 221 and the end edge 222a of the second portion 222 of the translucent member 22 are in contact with each other. However, those are not necessarily to be in contact with each other. FIG. 8 shows a left-front lamp device 2LF2 according to a second modification of the second embodiment for that case. Constituent elements common to the left-front lamp device 2LF are denoted by the same reference numerals, and repetitive explanation is omitted.

The left-front lamp device 2LF2 includes an opaque member 262. The opaque member 262 has a first end surface 262a and a second end surface 262b. The first end surface 262a is in contact with the end edge 221a of the first portion 221 of the translucent member 22. The second end surface 262b is in contact with the end edge 222a of the second portion 222 of the translucent member 22.

The opaque member 262 and the first portion 221 and the second portion 222 of the translucent member 22 may be bonded by adhesion, welding and the like, or may be provided as an integral molded product in advance. In the latter case, the number of parts can be reduced.

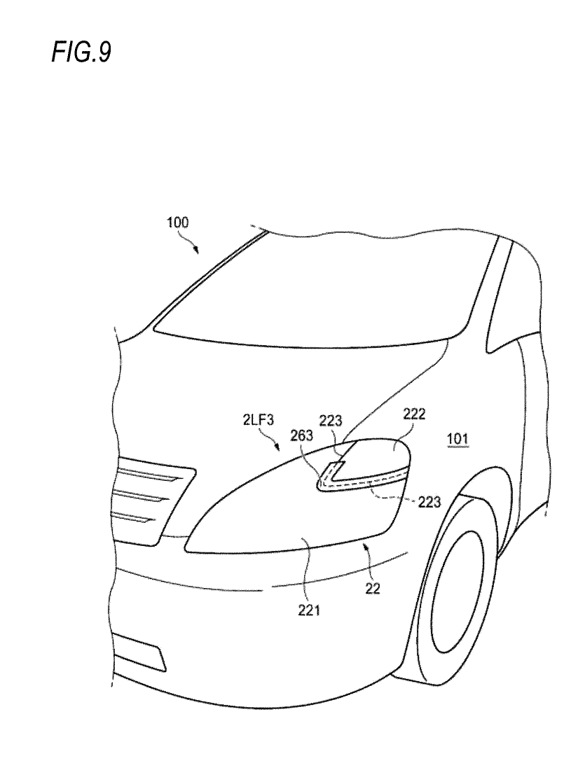

In the left-front lamp device 2LF, the opaque member 26 covers the entire end edge 221a of the first portion 221 and the entire end edge 222a of the second portion 222 of the translucent member 22. However, the opaque member may cover at least a part of at least one of the end edge 221a and the end edge 222a. FIG. 9 shows a left-front lamp device 2LF3 according to a third modification of the second embodiment for that case. Constituent elements common to the left-front lamp device 2LF are denoted by the same reference numerals, and repetitive explanation is omitted.

The left-front lamp device 2LF3 includes an opaque member 263. The opaque member 263 covers a part of the boundary 223 formed by the end edge 221a of the first portion 221 and the end edge 222a of the second portion 222 of the translucent member 22.

In the above embodiments, light emitted on the camera 25 linearly passes through the second portion 222 of the translucent member 22. However, at least a part of the second portion 222 may have a shape having a lens function.

According to this configuration, since the camera 25 performs the desired shooting operation, at least a part of the optical system disposed in the lamp room 23 may be omitted. Accordingly, an increase in size of the left-front lamp device 2LF can be suppressed.

In the above embodiments, a single housing space (the lamp room 23) is defined by the housing 21 and the translucent member 22. However, the inside of the housing space can be divided into a plurality of spaces by a partition plate and the like.

Each of the above embodiments is merely an example to facilitate understanding of the present invention. The configuration according to each of the embodiments can be modified or improved appropriately without departing from the spirit of the present invention. Further, it is apparent that equivalents fall within the technical scope of the present invention.

The anti-reflection layer 124 described with reference to the right-front lamp device 1RF1 in FIG. 3 may be applied to the inner surface of the second portion 222 of the translucent member 22 described with reference to FIGS. 5 to 9.

The silicone gel 126 described with reference to the right-front lamp device 1RF2 in FIG. 4 may be applied between the inner surface of the second portion 222 of the translucent member 22 and the camera 25 described with reference to FIGS. 5 to 9.

In the above embodiments, the lamp device is used as the right-front lamp device 1RF and the left-front lamp device 2LF. However, a configuration described with reference to the right-front lamp device 1RF and the left-front lamp device 2LF can also be applied to a left-back lamp device 1LB disposed in a left-back corner of the vehicle 100 and a right-back lamp device 1RB disposed in a right-back corner of the vehicle 100 shown in FIG. 1. For example, the right-back lamp device 1RB may have a configuration symmetrical with the right-front lamp device 1RF (the light source is appropriately changed). The left-back lamp device 1LB may have a configuration symmetrical with the left-front lamp device 2LF (the light source is appropriately changed). The left-back lamp device 1LB and the right-back lamp device 1RB may have a left-right symmetrical configuration.

1. A lamp device to be mounted on a vehicle, the lamp device comprising:
a housing;
a translucent member defining a housing space together with the housing;
a light source housed in the housing space; and
a sensor housed in the housing space and configured to detect information outside the vehicle,
wherein the translucent member includes a first portion and a second portion,
wherein the first portion includes a region through which light emitted from the light source passes and has first weather resistance, and
wherein the second portion includes a region opposing the sensor and has second weather resistance, and the second weather resistance is higher than the first weather resistance.

2. The lamp device according to claim 1, further comprising:
an opaque member covering at least one part of a first end edge of the first portion and at least one part of a second end edge of the second portion.

3. The lamp device according to claim 1, further comprising:
an opaque member having a portion which is flush with at least one of (i) at least one part of a first end edge of the first portion and (ii) at least one part of a second end edge of the second portion.

4. The lamp device according to claim 2,
wherein the opaque member presents a same color as a part of a vehicle body of the vehicle.

5. The lamp device according to claim 1,
wherein the second portion is smaller than the first portion.

6. The lamp device according to claim 1,
wherein the second portion includes a portion having a lens function.

7. The lamp device according to claim 1,
wherein the first portion and the second portion are a part of an integral molded product.

8. The lamp device according to claim 1,
wherein the sensor includes at least one of a LiDAR sensor, a millimeter wave radar, an ultrasonic sensor, and a camera.

9. The lamp device according to claim 1,
wherein the second portion is made of either one of glass, acrylic resin, and bio-polycarbonate resin.
